(19) United States
(12) Patent Application Publication
(10) Pub. No.: US 2002/0185498 A1
(43) Pub. Date: Dec. 12, 2002

(54) Beverage dispenser

(76) Inventors: Michael V. Riordan, Kissimmee, FL (US); Michael F. Mateo, Kissimmee, FL (US)

Correspondence Address: Edward M. Livingston, Esq., 628 Ellen Dr., P.O. Box 1599, Winter Park, FL, 32790, US

(21) Appl. No.: 09/837,676

(22) Filed: Apr. 18, 2001

(51) Int. Cl. B65H 3/00; G07F 11/16; B65G 59/00

(52) U.S. Cl. 221/196; 221/266; 221/289; 221/281

(57) ABSTRACT

A beverage dispenser has a case (1) with an inside periphery sized and shaped to hold a plurality of desired sizes and shapes of beverage containers (3, 4, 5 and 6) oriented horizontally and juxtaposed vertically while being maintained at or caused to become desirably cold or hot before being dispensed one at a time with a rotary gate (9) onto a pickup tray (14).

### BACKGROUND OF THE INVENTION

This invention relates to dispensers of cans or bottles of beverage for consumer use at homes, in club houses, on golf carts and other beverage-consumption places.

Numerous beverage dispensers and coolers are known, but not with a rotary outlet and optional temperature maintenance in a manner taught by this invention.

Examples of most-closely related known but different devices are described in the following patent documents:

| U.S. Pat. No. | | Issue |
|---|---|---|
| (U.S. unless stated otherwise) | Inventor | Date |
| 5,826,746 | Ash, Jr. | 10/27/1998 |
| 4,721,237 | Leslie | 01/26/1988 |
| 4,510,770 | Vella | 04/16/1985 |
| 5,395,011 | Kennedy | 03/07/1995 |
| 6,065,303 | Harris | 05/23/2000 |
| 5,356,033 | Delaney | 10/18/1994 |
| 2,212,129 | Rust | 08/20/1940 |
| G.B. 2,190,904 | Miles | 12/02/1987 |

### SUMMARY OF THE INVENTION

Objects of patentable novelty and utility taught by this invention are to provide a beverage dispenser which makes cans or bottles of beverage easily accessible for consumer use and maintains their temperatures desirably cold or hot for desirable lengths of time.

This invention accomplishes these and other objectives with a beverage dispenser having a case with an inside periphery sized and shaped to hold a plurality of a desired size and shape of bottles or cans of beverage oriented horizontally and juxtaposed vertically while being maintained at desirably cold or hot temperatures before being dispensed one at a time with a rotary outlet into a pickup tray.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a perspective view of an empty beverage dispenser;

FIG. 2 is a partially cutaway side view showing a rotary gate rotated to contain a beverage container in a gate pocket;

FIG. 3 is a partially cutaway side view of a bottom portion of the beverage dispenser with the rotary gate rotated half way between containing and discharging the beverage container in the gate pocket;

FIG. 4 is a partially cutaway side view of the bottom portion of the beverage container with the rotary gate rotated to discharge the beverage container, to prevent a next beverage container from being discharged and to prevent temperature loss vertically downward from a case of the beverage dispenser;

FIG. 5 is a partially cutaway front view showing the rotary gate rotated to contain a beverage container in the gate pocket;

FIG. 6 is a partially cutaway front view of the bottom portion of the beverage dispenser with the rotary gate rotated half way between containing and discharging the beverage container in the gate pocket;

FIG. 7 is a partially cutaway front view of the bottom portion of the beverage container with the rotary gate rotated to discharge the beverage container, to prevent a next beverage container from being discharged and to prevent temperature loss vertically downward from a case of the beverage dispenser;

FIG. 8 is a partially cutaway front view of the bottom portion of the beverage dispenser that is articulated to contain and to dispense an optionally wide-neck beverage container that is conveniently consumer filled with hot or cold beverage;

FIG. 9 is a partially cutaway front view of the bottom portion of the beverage dispenser that is articulated to contain and to dispense an optionally narrow-neck beverage container that can be conveniently consumer filled or commercially filled at low cost with hot or cold beverage;

FIG. 10 is a partially cutaway front view of the bottom portion of the beverage dispenser that is articulated to contain and to dispense optionally long-neck beverage containers, including wine and beer bottles;

FIG. 11 is a partially cutaway side view of the beverage dispenser with walls having a rubber-like heat barrier;

FIG. 12 is a partially cutaway side view of the beverage dispenser with walls having a gaseous heat barrier that can include air;

FIG. 13 is a partially cutaway side view of the beverage dispenser with walls having a liquid heat barrier;

FIG. 14 is a partially cutaway side view of the beverage dispenser with walls having an antifreeze heat barrier to be filled at a top with freezer-cooled or heater-heated antifreeze to be emptied at a bottom with a liquid receptacle;

FIG. 15 is a rear view of the beverage dispenser with dispenser fasteners;

FIG. 16 is a front view of the beverage dispenser with side item fasteners and with front miscellaneous containers; and

FIG. 17 is a side view of the FIG. 16 illustration.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. Case | 19. Rubber-like material |
| 2. Container ends | 20. Rigid outside layer |
| 3. Cylindrical containers | 21. Rigid inside layer |
| 4. Wide-neck containers | 22. Gaseous material |
| 5. Narrow-neck containers | 23. Liquid material |
| 6. Long-neck containers | 24. Liquid inlet |
| 7. Case walls | 25. Liquid outlet |
| 8. Case lid | 26. Liquid receptacle |
| 9. Rotary gate | 27. Receptacle-inlet connection |
| 10. Gate pocket | 28. Receptacle-outlet connection |
| 11. Pocket wall | 29. Hooks |
| 12. Gate knob | 30. Clamps |
| 13. Gate axle | 31. Miscellaneous containers |
| 14. Pickup tray | 32. Fastener-head aperture |
| 15. Stop wall | 33. Fastener rod |
| 16. Tray bottom | 34. Back wall |
| 17. Tray aperture | 35. Rubber-like cushion |
| 18. Homogeneous material | |

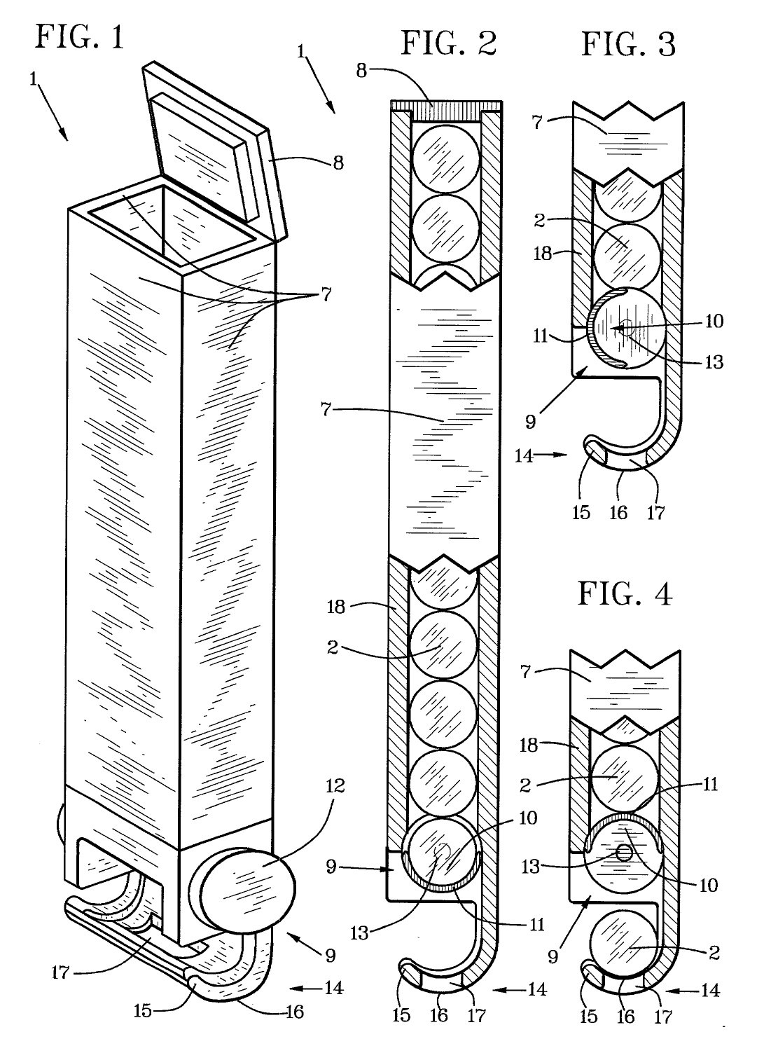

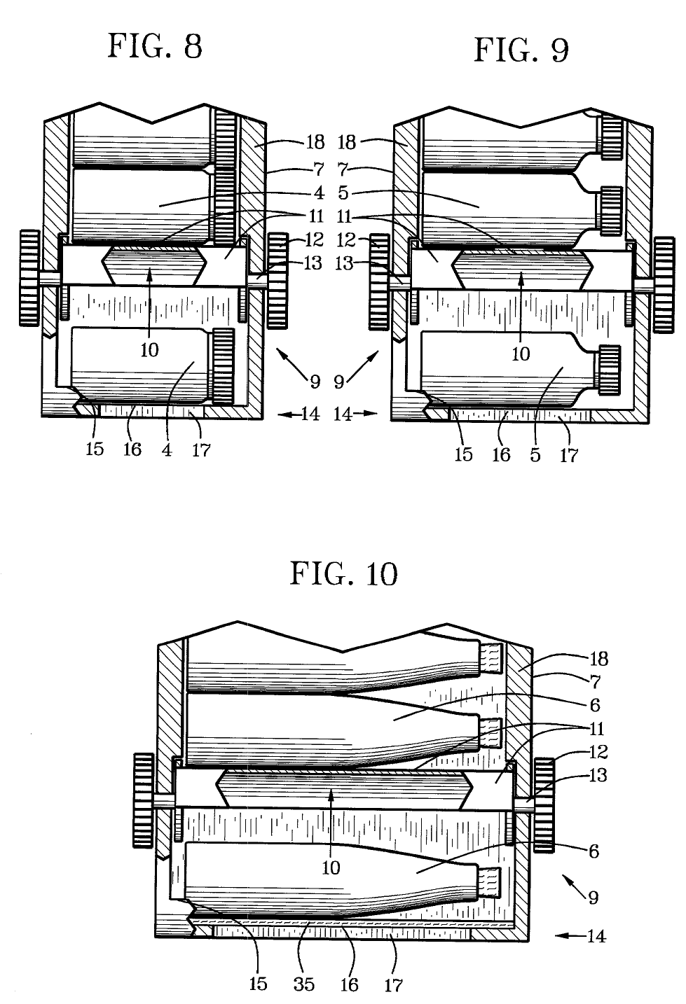

Referring first to FIGS. 1-7, the beverage dispenser includes a beverage case 1 that is sized and shaped to hold a plurality of a predetermined size and shape of beverage containers that are elongate, oriented horizontally and juxtaposed vertically. The beverage containers are preferably round as illustrated by container ends 2 of round containers in FIGS. 2-3 and 11-14. The beverage containers can be cylindrical containers 3 as illustrated in FIGS. 5-7, wide-neck containers 4 as illustrated in FIG. 8, narrow-neck containers 5 as illustrated in FIG. 9, long-neck containers 6 as illustrated in FIG. 10 or other compatibly dimensioned containers that fit within case walls 7 that preferably are orthogonally rectangular and elongate between a case lid 8 and a rotary gate 9.

The cylindrical containers 3 can include conventional beer cans and soft-drink cans. The wide-neck containers 4 can include jars that have large openings for ease of consumer filling with hot or cold beverages. The narrow-neck containers 5 can have either screw-on or press-on lids for generally commercial use. The long-neck containers 6 can include wine, beer and soft-drink containers.

After inserting the beverage containers 3, 4, 5 or 6 in the case 1, ice can be placed in to the top of the case on top of the beverage containers and the lid 8 closed to help maintain the beverage containers in a cool condition.

The rotary gate 9 has a gate pocket 10 with a pocket opening that is circumferentially opposite a pocket wall 11 that is preferably heat resistant to resist loss of desirably high or low heat downwardly. The pocket opening is articulated for entry of one of the beverage containers 3, 4, 5 or 6 when the rotary gate 9 is rotated to a circumferential orientation in which the pocket opening is in communication with the inside periphery of the case 1. The pocket opening is articulated for discharge of the beverage container 3, 4, 5 or 6 from the gate pocket 10 when the rotary gate 9 is rotated to an orientation in which the pocket opening 10 is not in communication with the inside periphery of the case 1 and the pocket wall 11 is rotated to a position of closure of the inside periphery of the case 1.

The rotary gate 9 has a gate knob 12 on a gate axle 13 for rotating the rotary gate 9 to orient the pocket opening upwardly to receive and downwardly to discharge a beverage container 3, 4, 5 or 6 one at a time as desired. The gate pocket 10 includes an inside periphery that is bounded by slightly less than one-hundred-and-eighty degrees of the pocket wall 11 cylindrically and by circumferential end plates that are attached to the gate axle 13. The pocket opening includes a remaining slightly more than one-hundred-and-eighty degrees cylindrically intermediate the circumferential end plates and the pocket wall 11.

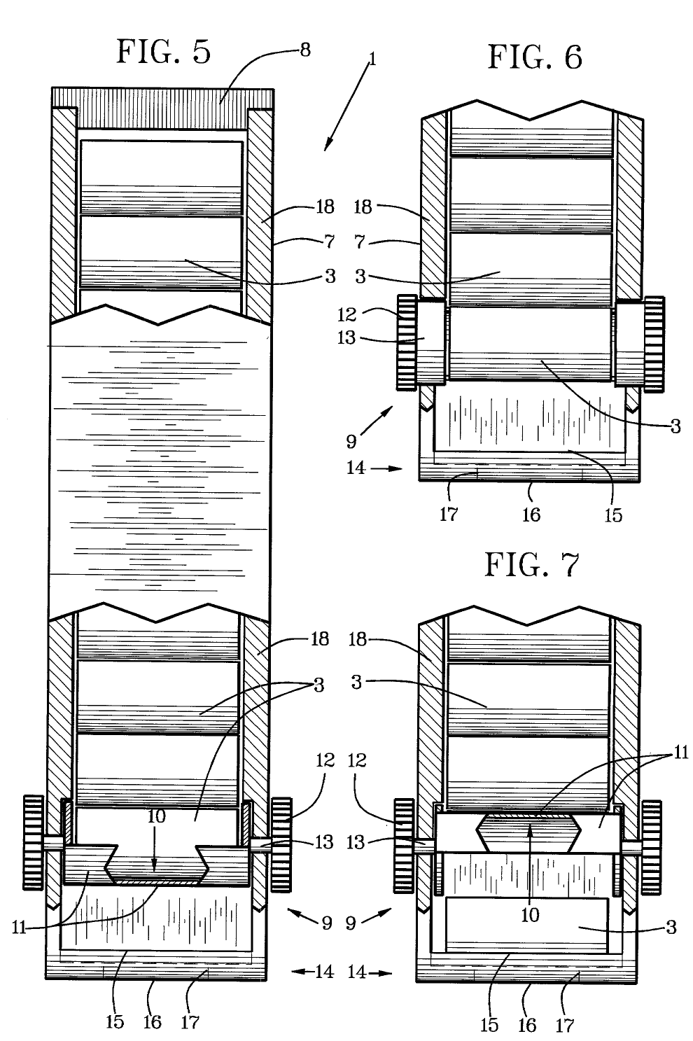

Rotating in axle-bearing apertures in the case walls 7, the gate axle 13 can have a relatively small diameter for low friction as shown in FIGS. 5 and 7-10 or a larger diameter for higher bearing capacity as shown in FIG. 6 in accordance with requirements for particular construction material and related cost factors.

To receive discharged beverage containers 3, 4, 5 or 6 one at a time at a position vertically under the rotary gate 9 is a pickup tray 14 that can include a stop wall 15 that is extended upwardly from a tray bottom 16. The tray bottom 16 can include a tray aperture 17 for discharge of moisture from melting ice or condensation and for finger insertion to assist removal of the beverage containers 3, 4, 5 or 6 from the pickup tray 14.

Referring to FIGS. 2-14, the case walls 7 have a predetermined heat-loss resister for resisting temperature change through them. The heat-loss resister can include a homogeneous material 18 that is rigid, heat-resistant plastic or other material from which the case walls 7 are constructed as illustrated in FIGS. 2-10.

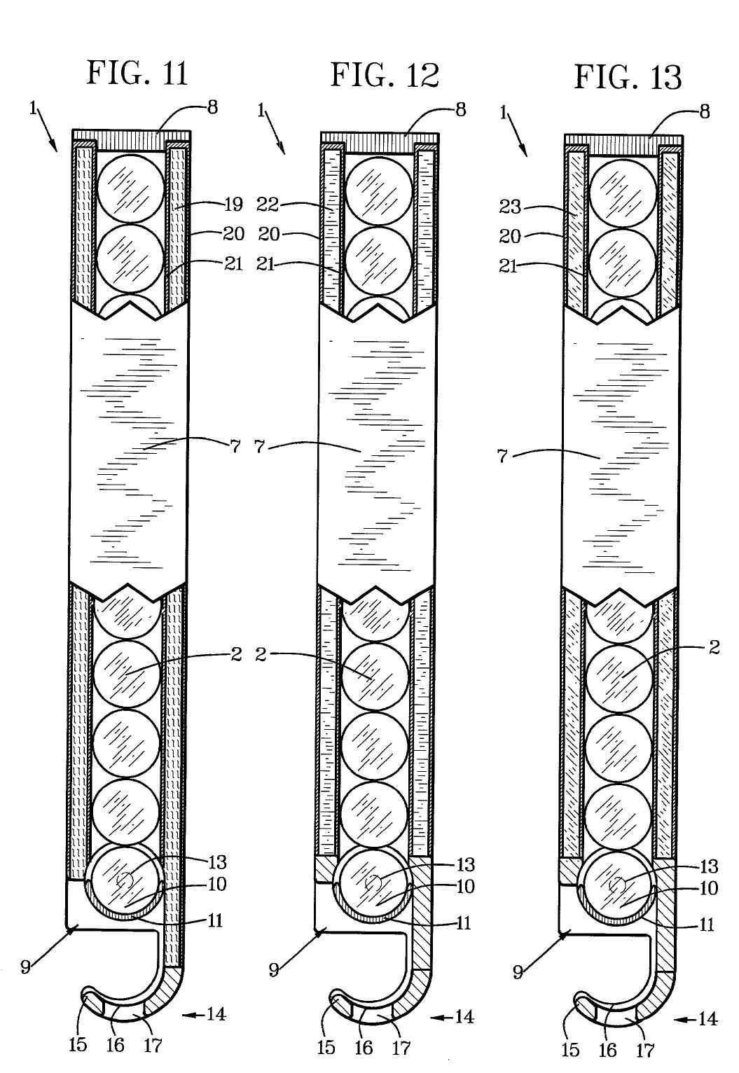

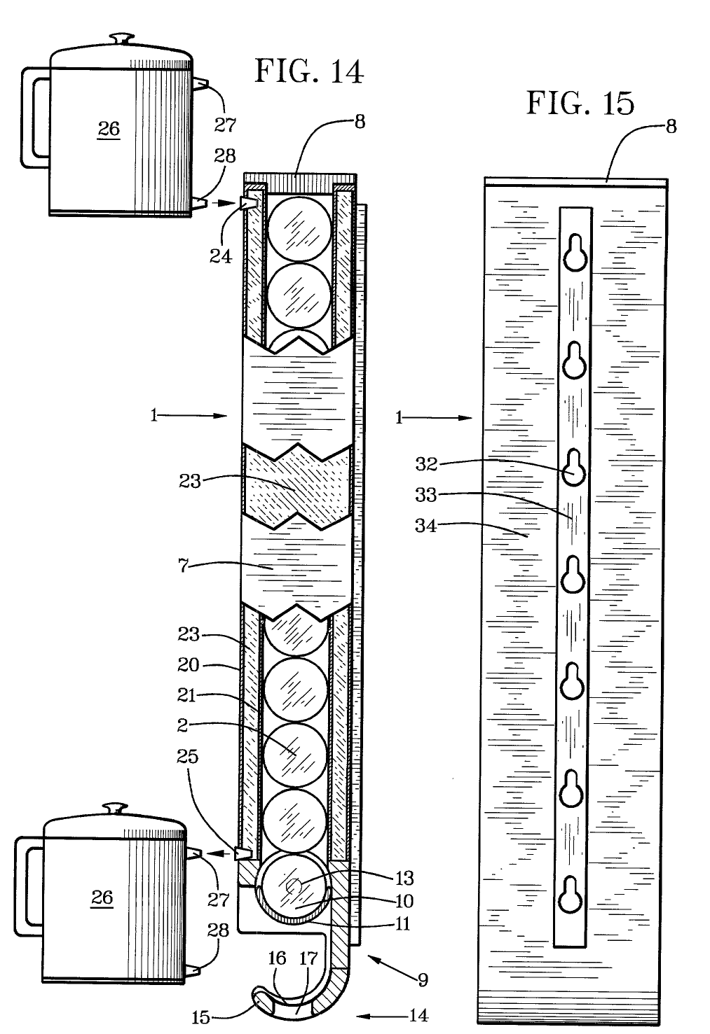

As illustrated in FIG. 11, the predetermined heat-loss resister can include a rubber-like material 19 or other heat-impervious material having a rigid outside layer 20 and preferably also a rigid inside layer 21. As illustrated in FIG. 12, the predetermined heat-loss resister can be a gaseous material 22, including air, between the rigid outside layer 20 and the rigid inside layer 21. As illustrated in FIGS. 13-14, the predetermined heat-loss resister can include a liquid material 23, including antifreeze, between the rigid outside layer 20 and the rigid inside layer 21. Preferably, antifreeze as the liquid material 23 contains a perfume for compatibility with use conditions related to entertainment.

The heat-loss resister of the case walls 7 can include a heat conveyor which can be the liquid material 23, including antifreeze, in a conveyance container that includes space intermediate the inside periphery which includes the rigid inside layer 21 and the outside periphery which includes the rigid outside layer 20 of the case walls 7. The heat conveyor can be the liquid material 23, which includes the antifreeze, to which a desired temperature can be transmitted for conveyance of the desired temperature to the beverage containers 3, 4, 5 or 6.

In a conveyance container intermediate the rigid outside layer 20 and the rigid inside layer 21 illustrated in FIG. 14, a liquid inlet 24 proximate a top of the conveyance container and a liquid outlet 25 proximate a bottom of the conveyance container are closable predeterminedly and controllably. A liquid receptacle 26 has a receptacle-inlet connection 27 proximate a top and a receptacle-outlet connection 28 proximate a bottom of the liquid receptacle 26.

The receptacle-inlet connection 27 is fluidly communicative predeterminedly and preferably exclusively with the liquid outlet 25 for conveyance of the liquid from the conveyance container to the liquid receptacle 26. The receptacle-outlet connection 28 is fluidly communicative predeterminedly and preferably exclusively with the liquid inlet 24 for conveyance of the liquid from the liquid receptacle 26 to the conveyance container.

Preferably, the liquid receptacle 26 is articulated to be positioned in a predetermined refrigeration case that can include a freezer to cool the liquid therein for cooling the beverage in the beverage containers 3, 4, 5 or 6. Preferably also the liquid receptacle 26 is articulated to be positioned on a predetermined heater to heat the liquid therein for heating the beverage. The liquid receptacle 26 can have a handle, a heat-exchange wall and a heat-exchange bottom accordingly. This provides convenient heating and cooling of beverages in the beverage containers 3, 4, 5 or 6.

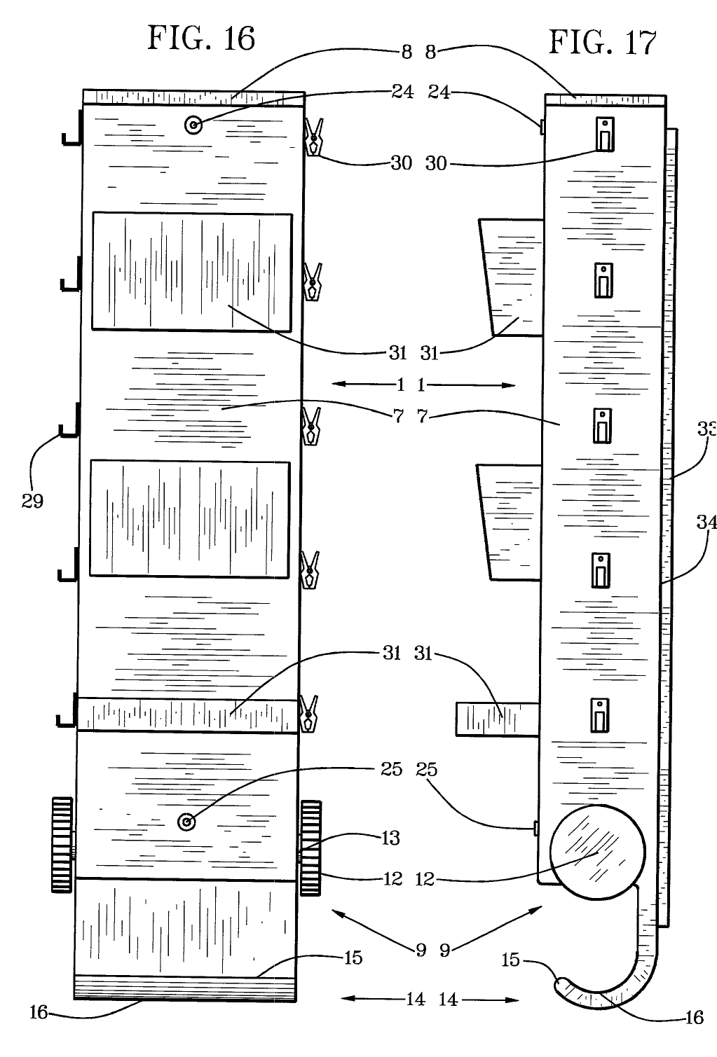

Referring to FIGS. 16-17, one or more fasteners, including hooks 29 and clamps 30, can be attached to outside surfaces of the case walls 7 for holding snacks and desired containers. Miscellaneous containers 31 also can be attached to the case walls 7. This allows convenient access to napkins, utensils, snacks, game items, golf score cards, music items and other items associated generally with beverage consumption by consumers.

Referring to FIGS. 15 and 17, one or more dispenser fasteners are placed on one or more outside surfaces of one or more of the case walls 7 for fastening the beverage dispenser to stationary, mobile or portable support structure. Suitable as a dispenser fastener for most purposes is a fastener-head aperture 32 shown in FIG. 15 in a fastener rod 33 on a back wall 34 of the case 1.

The fastener-head aperture 32 allows easy and fast placing of the beverage dispenser on a head of a fastener or on heads of more than one fastener and then removing it by simply raising the case 1 slightly and moving it in a direction away from a support structure on which fastener heads are placed with distance of separation from the support structure to accommodate wall thickness of the fastener rod 33 containing the fastener-head aperture 32. Easy removal from and replacement of the beverage dispenser on a support structure is particularly important for placing beverage containers 3, 4, 5 or 6 that are glass in the case 1.

Placing glass containers in the case 1 without dropping them in and breaking them is accomplished by removing the case 1 from its support structure, laying it or otherwise orienting it horizontally on its back wall 34 or on the fastener rod 33 and then rolling the glass containers inside of the case 1 on the horizontal back wall 34 towards the rotary gate 9, described in relation to FIGS. 1-10.

Removing the glass beverage containers 3, 4, 5 or 6 through the rotary gate 9 from which they drop to the pickup tray 14 without breakage is accomplished by placing a rubber-like cushion 35 on the pickup tray 14 as illustrated in FIG. 10. The rubber-like cushion 35 can cover the tray aperture 17 and be raised with fingers if necessary for removal of the beverage containers 3, 4, 5 or 6 from the pickup tray 14. Optionally, the rubber-like cushion 35 can include water-discharge orifices if ice is put into the case 1 for cooling effect instead of using the antifreeze system for heating or cooling as described in relation to FIG. 14.

Some consumers will prefer to have separate beverage dispensers for heating and cooling beverages and might like to mix sizes, shapes and types of beverage containers 3, 4, 5 or 6 in a single case 1.

A new and useful beverage dispenser having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A beverage dispenser comprising:
a case having an inside periphery sized and shaped to hold a plurality of a predetermined size and shape of beverage containers that are elongate, oriented horizontally and juxtaposed vertically;
the case having four case walls positioned orthogonally to encompass ends and sides of the beverage containers horizontally;
a case top having a case inlet orifice for receiving the beverage containers;
the case inlet orifice having a case lid to protect beverage in the beverage containers against temperature change upwardly;
a case bottom having a rotary gate that is rotatable on a gate axle proximate the case bottom;
the rotary gate having a gate pocket for receiving one of the beverage containers;
the gate pocket having a pocket opening that is circumferentially opposite a pocket wall;
the pocket opening being articulated for entry of one of the beverage containers into the gate pocket when the rotary gate is rotated to a circumferential orientation in which the pocket opening is in communication with the inside periphery of the case;
the pocket opening being articulated for discharge of the one of the beverage containers from the gate pocket when the rotary gate is rotated downwardly to a position in which the pocket opening is not in communication with the inside periphery of the case and the pocket wall is rotated to a position of closure of the inside periphery of the case; and
the rotary gate having a gate knob on the gate axle for rotating the rotary gate to orient the pocket opening upwardly to receive and downwardly to discharge the one of the beverage containers for dispensing the beverage containers one at a time as desired.

2. The beverage dispenser of claim 1 and further comprising:
a pickup tray vertically under the rotary gate to receive the beverage containers that are dispensed one at a time as desired.

3. The beverage dispenser of claim 2 wherein:
the pickup tray includes at least one stop wall that is extended upwardly from a tray bottom.

4. The beverage dispenser of claim 3 wherein:
the tray bottom is elongate horizontally and includes a tray aperture for discharge of moisture and for finger insertion to assist removal of the containers from the pickup tray.

5. The beverage dispenser of claim 1 wherein:
the predetermined size and shape of beverage containers includes conventionally sized soft-drink cans and beer cans.

6. The beverage dispenser of claim 1 wherein:
the predetermined size and shape of beverage containers includes conventionally sized soft-drink bottles and beer bottles.

7. The beverage dispenser of claim 6 wherein:
the soft-drink bottles and the beer bottles have conventionally long bottle necks.

8. The beverage dispenser of claim 6 wherein:
the soft-drink bottles and the beer bottles have conventionally short bottle necks.

9. The beverage dispenser of claim 1 wherein:
the case walls have a predetermined heat-loss resister for resisting temperature change through the case walls.

10. The beverage dispenser of claim 9 wherein:
the predetermined heat-loss resister of the case walls includes rigid thickness of a predeterminedly temperature-resistant material with which the case walls are constructed.

11. The beverage dispenser of claim 9 wherein:
the predetermined heat-loss resister of the case walls includes a heat barrier intermediate an inside and an outside periphery of the case walls.

12. The beverage dispenser of claim 11 wherein:
the heat barrier includes a rubberlike material.

13. The beverage dispenser of claim 11 wherein:
the heat barrier includes a gaseous substance having heat-resistance characteristics.

14. The beverage dispenser of claim 13 wherein:
the gaseous substance includes air.

15. The beverage dispenser of claim 1 wherein:
the predetermined heat-loss resister of the case walls includes a heat conveyor in a conveyance container intermediate the inside and the outside periphery of the case walls.

16. The beverage dispenser of claim 15 wherein:
the heat conveyor includes a liquid to which desired low and high levels of heat can be transmitted for conveyance to the beverage containers.

17. The beverage dispenser of claim 16 and further comprising:
a liquid inlet that is predeterminedly closable proximate a top of the conveyance container; and
a liquid outlet that is predeterminedly closable proximate a bottom of the conveyance container.

18. The beverage dispenser of claim 17 and further comprising:
a liquid receptacle having a receptacle-inlet connection proximate a top and a receptacle-outlet connection proximate a bottom of the liquid receptacle;
the receptacle-inlet connection being fluidly communicative with the liquid outlet for conveyance of the liquid from the conveyance container to the liquid receptacle; and
the receptacle-outlet connection being fluidly communicative with the liquid inlet for conveyance of the liquid from the liquid receptacle to the conveyance container.

19. The beverage dispenser of claim 18 wherein:
the liquid has a predetermined low freezing point and a predetermined high boiling point.

20. The beverage dispenser of claim 19 wherein:
the liquid includes a predetermined antifreeze.

21. The beverage dispenser of claim 20 wherein:
the antifreeze includes a predetermined perfume.

22. The beverage dispenser of claim 20 wherein:
the liquid receptacle is articulated to be positioned in a predetermined refrigeration case to cool the liquid therein for cooling the beverage in the beverage containers.

23. The beverage dispenser of claim 20 wherein:
the heat-conveyance receptacle is articulated to be positioned on a predetermined heater to heat the liquid therein for heating the beverage in the beverage containers.

24. The beverage dispenser of claim 1 wherein:
the pocket wall includes predetermined heat resistance.

25. The beverage dispenser of claim 1 and further comprising:
one or more fasteners on one or more outside surfaces of one or more of the case walls for fastening food packets and other items to the beverage dispenser.

26. The beverage dispenser of claim 1 and further comprising:
one or more miscellaneous containers on one or more outside surfaces of one or more of the case walls for containing miscellaneous items.

27. The beverage dispenser of claim 1 and further comprising:
one or more dispenser fasteners on one or more outside surfaces of one or more of the case walls for fastening the beverage dispenser to support structure.

28. The beverage dispenser of claim 1 and further comprising:
a rubber-like cushion on the pickup tray.
